(19) United States
(12) Patent Application Publication
(10) Pub. No.: US 2026/0163444 A1
(43) Pub. Date: Jun. 11, 2026

(54) POWER TOOL HAVING BUSBARS

(71) Applicant: MILWAUKEE ELECTRIC TOOL CORPORATION, Brookfield, WI (US)

(72) Inventors: Zoltan Polik, Menomonee Falls, WI (US); Anthony E. Breitbach, Muskego, WI (US); Daniel M. Blau, Milwaukee, WI (US)

(21) Appl. No.: 19/409,942

(22) Filed: Dec. 5, 2025

Related U.S. Application Data
(60) Provisional application No. 63/728,374, filed on Dec. 5, 2024.

(51) Int. Cl. H02K 5/22; B25F 5/02; H02K 9/04

(52) U.S. Cl. CPC H02K 5/225; B25F 5/02; H02K 9/04; H02K 2211/03

(57) ABSTRACT

A power tool may include a housing. A power tool may include an electric motor. A power tool may include a printed circuit board assembly configured to supply electrical current to the electric motor. A power tool may include an output unit operably coupled to the electric motor. A power tool may include a tool terminal block supported by the housing and including a tool terminal configured to electrically couple to the battery pack. A power tool may include a busbar extending between and electrically connecting the tool terminal to the printed circuit board assembly, wherein a portion of the busbar defines the tool terminal.

### CROSS-REFERENCE TO RELATED APPLICATIONS

The present application claims priority to U.S. Provisional Ser. No. 63/728,374, filed Dec. 5, 2024, the entire content of which is incorporated herein by reference.

### FIELD

The present disclosure relates to power tools, and more particularly, to a portable, battery-powered power tool.

### BACKGROUND

Power tools, especially those operating at high power levels, rely on efficient electrical connections to ensure optimal performance. Traditional interconnects, such as B+ and B− wires and phase wires to the electric motor, are typically made from conductive metal wires of various gauges which are typically surrounded by an insulation sheath. These wires have limitations related to contact resistance at the solder joints, heat dissipation due to the insulation on the wires, and assembly complexity due to the soldering required during assembly.

### SUMMARY

In some aspects, the techniques described herein relate to a power tool configured to selectively and removably couple to a battery pack, the power tool including: a housing; an electric motor; a printed circuit board assembly configured to supply electrical current to the electric motor; an output unit operably coupled to the electric motor; a tool terminal block supported by the housing and including a tool terminal configured to electrically couple to the battery pack; and a busbar extending between and electrically connecting the tool terminal to the printed circuit board assembly; wherein at least a portion of the busbar defines the tool terminal.

In some aspects, the techniques described herein relate to a power tool, wherein the housing includes a resin material, and wherein the busbar is at least partially embedded within the resin material.

In some aspects, the techniques described herein relate to a power tool, wherein the busbar is insert molded with the housing.

In some aspects, the techniques described herein relate to a power tool, wherein the busbar is rigid and includes a plurality of straight segments connected by a plurality of non-linear portions.

In some aspects, the techniques described herein relate to a power tool, wherein the plurality of straight segments includes a first segment, a second segment, a third segment, and a fourth segment oriented non-parallel to one another and joined at the non-linear portions.

In some aspects, the techniques described herein relate to a power tool, wherein the busbar includes a first end and a second end, the tool terminal being located at the first end, and the second end defining an aperture configured to receive a screw that fastens the second end to the printed circuit board assembly.

In some aspects, the techniques described herein relate to a power tool, wherein the busbar is a first busbar and the tool terminal is a first tool terminal, and wherein the power tool further includes a second tool terminal and a second busbar extending between and electrically connecting the second tool terminal and the printed circuit board assembly.

In some aspects, the techniques described herein relate to a power tool, wherein the busbar includes a single monolithic conductive member formed of a conductive metal selected from copper, zinc, aluminum, or an alloy thereof.

In some aspects, the techniques described herein relate to a power tool, wherein at least a portion of the busbar is exposed within the housing to an airflow generated by a fan of the power tool to dissipate heat.

In some aspects, the techniques described herein relate to a power tool, wherein the portion of the busbar that is exposed is thermally coupled to a heat sink disposed within the housing.

In some aspects, the techniques described herein relate to a power tool, wherein the busbar includes a first end and a second end, the tool terminal being located at the first end, and the second end being electrically attached to the printed circuit board assembly by a solder connection.

In some aspects, the techniques described herein relate to a power tool, wherein the power tool further includes a plurality of phase busbars electrically connecting the printed circuit board assembly to respective phase windings of the electric motor.

In some aspects, the techniques described herein relate to a power tool, wherein an end of each phase busbar is secured to a stator insulator of the electric motor.

In some aspects, the techniques described herein relate to a power tool, wherein each phase busbar includes a single monolithic conductive member formed of a conductive metal and coupled to the housing by molding.

In some aspects, the techniques described herein relate to a power tool, wherein the tool terminal is a male terminal configured to be received by a corresponding female terminal of the battery pack.

In some aspects, the techniques described herein relate to a busbar for a portable, battery-powered power tool, the busbar including: a single monolithic conductive member having: a first end defining a tool terminal configured to mate with a battery pack terminal, a second end configured to electrically attach to a printed circuit board assembly, and a plurality of straight segments joined by non-linear portions between the first end and the second end; wherein the busbar is rigid and formed from a conductive metal.

In some aspects, the techniques described herein relate to a busbar, wherein the second end defines a mounting aperture configured to receive a threaded fastener to couple the busbar to the printed circuit board assembly.

In some aspects, the techniques described herein relate to a busbar, wherein the busbar is configured to be insert-molded into a housing of the portable, battery-powered power tool.

In some aspects, the techniques described herein relate to a method of assembling a portable, battery-powered power tool, the method including: insert-molding a busbar in a housing of the portable, battery-powered power tool, the busbar having a first end and a second end; and electrically attaching the second end of the busbar to a printed circuit board assembly of the portable, battery-powered power tool; wherein the first end of the busbar defines a tool terminal configured to mate with a battery pack terminal of a battery pack.

In some aspects, the techniques described herein relate to a method, further including inserting a screw through an aperture in the second end of the busbar and fastening the second end to the printed circuit board assembly via the screw, wherein the busbar is rigid and is formed of copper, zinc, aluminum, or an alloy thereof.

### BRIEF DESCRIPTION OF THE DRAWINGS

FIG. 1 is a side view of a prior art power tool with a portion of a housing removed.

FIG. 2 is a partial perspective view of a terminal block of the prior art power tool of FIG. 1.

FIG. 3 is a perspective view of a battery pack.

FIG. 4 is a side view of a power tool according to an embodiment of the present disclosure, with a portion of a housing removed.

FIG. 5 is a partial perspective view of a terminal block of the power tool of FIG. 4.

FIG. 6 is a perspective view of power busbars of the power tool of FIG. 4.

FIG. 7A is a partial perspective view of the power busbar of FIG. 6 attached to a printed circuit board assembly (PCBA) of the power tool of FIG. 4.

FIG. 7B is a partial perspective view of the power busbar of FIG. 6 attached to a printed circuit board assembly (PCBA) of the power tool of FIG. 4 according to another embodiment of the disclosure.

FIG. 8 is a partial side view of a housing of the power tool of FIG. 4 and the power busbar of FIG. 6.

FIG. 9 is a schematic view showing portions of the power tool of FIG. 4 including a plurality of phase busbars.

### DETAILED DESCRIPTION

Before any independent embodiments of the disclosure are explained in detail, it is to be understood that the disclosure is not limited in its application to the details of construction and the arrangement of components set forth in the following description or illustrated in the following drawings. The disclosure is capable of other independent embodiments and of being practiced or of being carried out in various ways.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof.

Relative terminology, such as, for example, “about”, “approximately”, “substantially”, etc., used in connection with a quantity or condition would be understood by those of ordinary skill to be inclusive of the stated value and has the meaning dictated by the context (for example, the term includes at least the degree of error associated with the measurement of, tolerances (e.g., manufacturing, assembly, use, etc.) associated with the particular value, etc.). Such terminology should also be considered as disclosing the range defined by the absolute values of the two endpoints. For example, the expression “from about 2 to about 4” also discloses the range “from 2 to 4.” The relative terminology may refer to plus or minus a percentage (e.g., 1%, 5%, 10% or more) of an indicated value.

Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

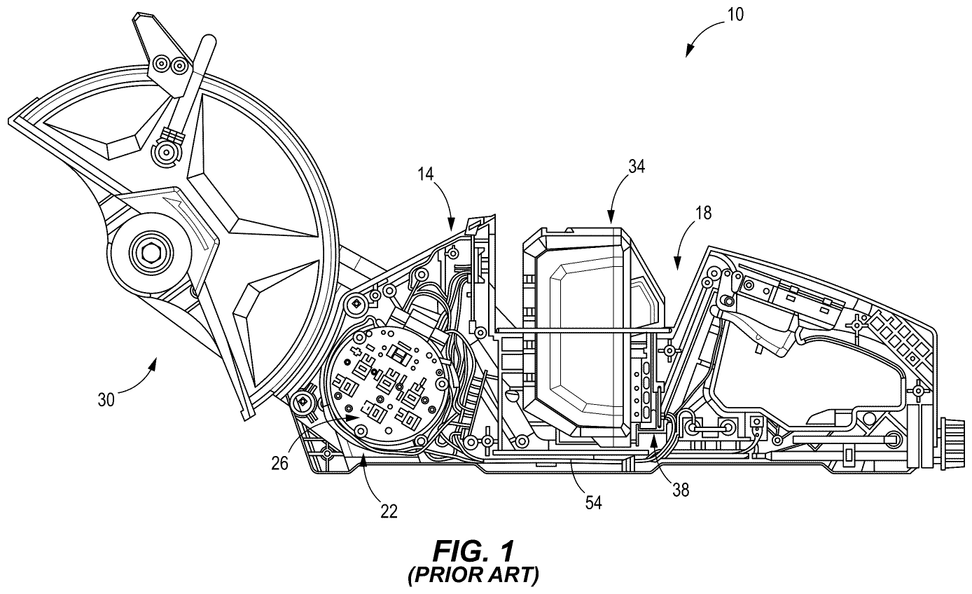

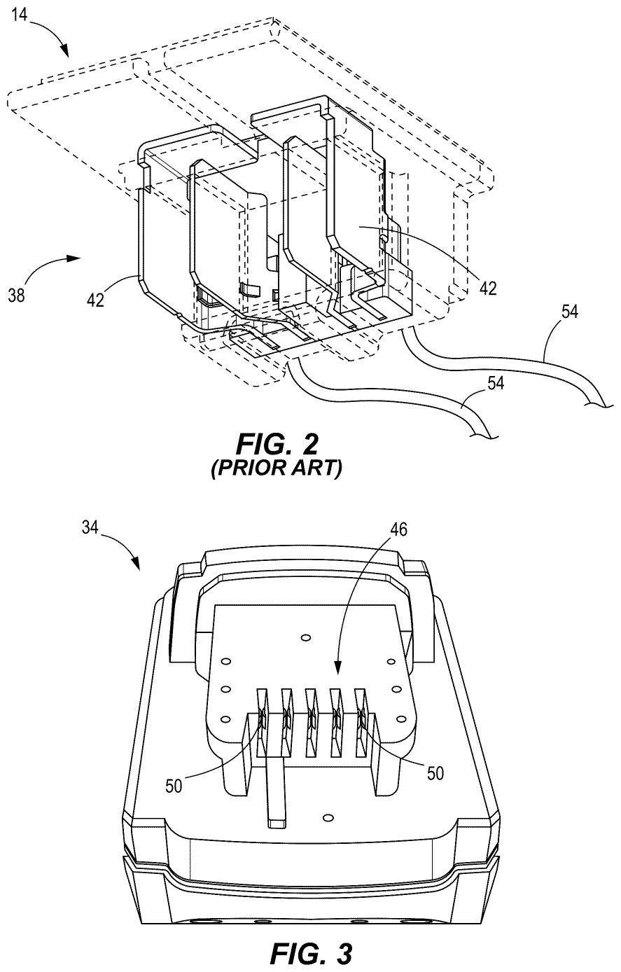

FIGS. 1 and 2 illustrate all or portions of a prior art power tool 10 (e.g., a cut-off saw). The power tool 10 includes a housing 14, a battery receptacle 18, an electric motor 22, a printed circuit board assembly (PCBA) 26, and an output unit 30. The electric motor 22 is operably coupled to the output unit 30 to supply torque to the output unit 30. The PCBA 26 supplies electrical current to the electric motor 22 to electronically commutate the electric motor 22. The battery receptacle 18 selectively couples to a removable battery pack 34. The battery receptacle 18 includes a tool terminal block 38 (FIG. 2) having a plurality of tool terminals 42 (e.g., male terminals, such as blade terminals). The battery pack 34 (FIG. 3) includes a corresponding battery terminal block 46 having a plurality of battery terminals 50 (e.g., female terminals, such as spring clamp terminals), which receive the tool terminals 42 when the battery pack 34 is coupled to the power tool 10.

FIG. 2 illustrates the tool terminal block 38 of the prior art power tool 10. The tool terminals 42 are connected to power wires 54 (e.g., via soldering), which extend from the tool terminals 42 to the PCBA 26 (FIG. 1). The power wires 54 electrically connect the tool terminals 42 to the PCBA 26 and enable electrical current to flow from the battery pack 34 to the PCBA 26. The ends of the power wires 54 typically attach to the PCBA 26 and to the tool terminals 42 via soldered connections.

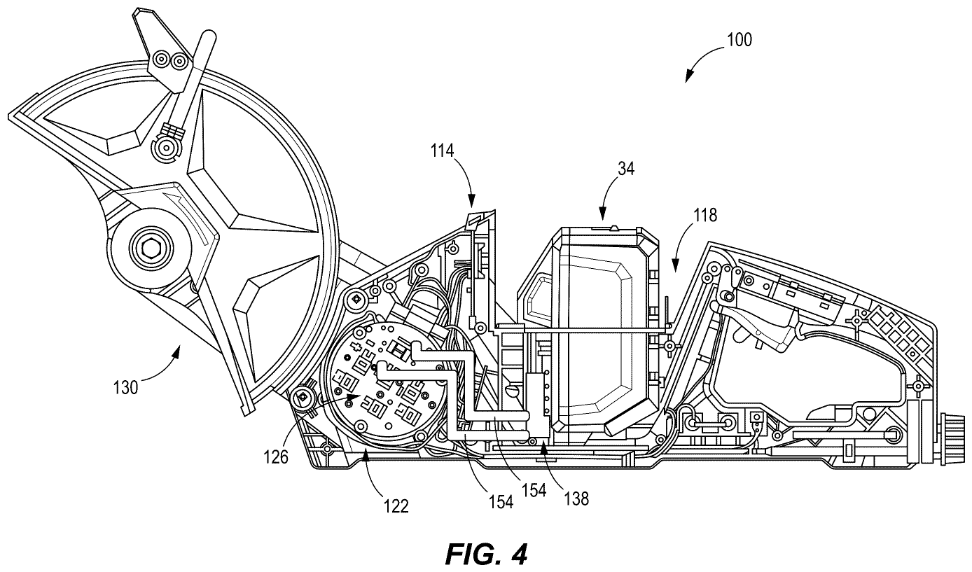

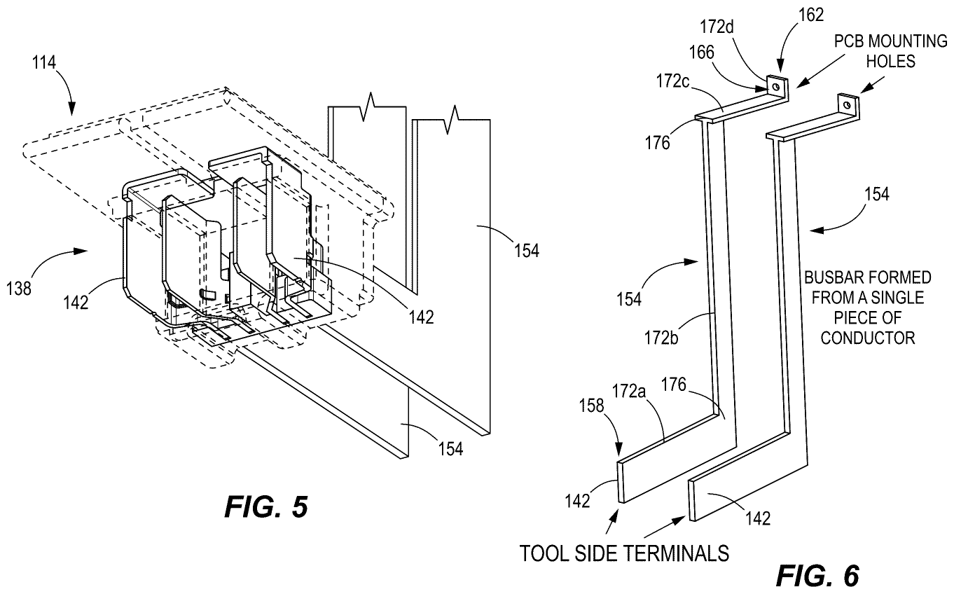

FIGS. 4-8 illustrate a power tool 100 according to an embodiment of the present disclosure. Like the power tool 10, the power tool 100 includes a housing 114, a battery receptacle 118, an electric motor 122, a printed circuit board assembly (PCBA) 126, and an output unit 130. The electric motor 122 is operably coupled to the output unit 130 to supply torque to the output unit 130. The PCBA 126 supplies electrical current to the electric motor 122 to electronically commutate the electric motor 122. The battery receptacle 118 selectively couples to the removable battery pack 34 (FIG. 3). The battery receptacle 118 includes a tool terminal block 138 (FIG. 5) having a plurality of tool terminals 142 (e.g., male terminals, such as blade terminals). The battery terminals 50 of the battery pack 34 receive the tool terminals 142 when the battery pack 34 is coupled to the power tool 100.

The power tool 100 does not include power wires connecting the tool terminals 142 to the PCBA 126. Instead, the power tool 100 includes busbars 154 which electrically connect the PCBA 126 to the battery pack 34. The busbars 154 are formed from a conductive metal (e.g., copper, zinc, aluminum, alloys thereof, or other metals). Each busbar 154 can comprise a single monolithic part and can be relatively rigid, i.e., inflexible, unlike the power wires 54 of the prior art.

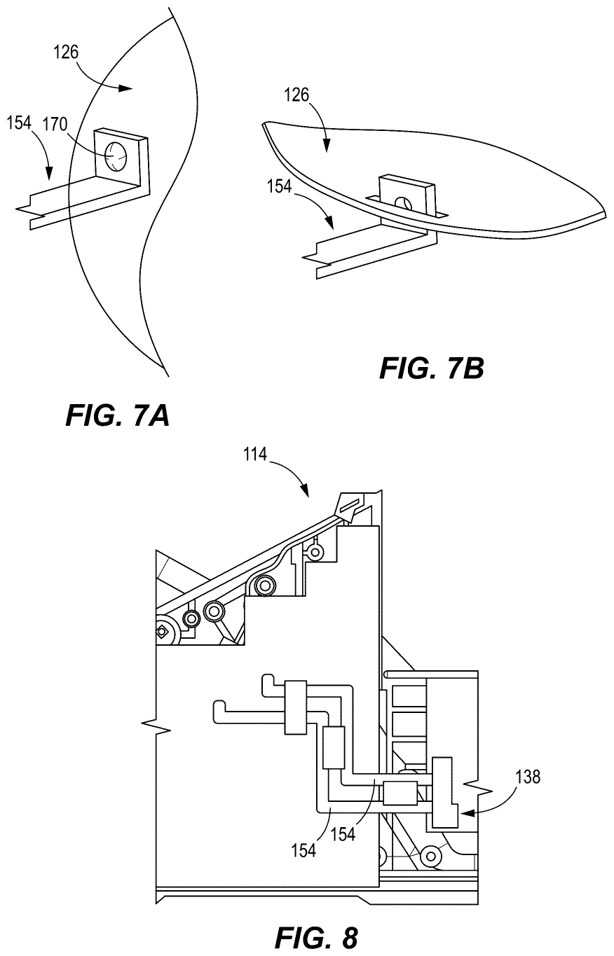

With reference to FIGS. 4-6, in the illustrated embodiment, each busbar 154 includes a first end 158 and a second end 162 opposite the first end. The first end 158 of each busbar 154 defines the tool terminals 142. As such, the first end 158 does not need to be soldered or otherwise electrically joined to a separate tool terminal component, which results in lower impedance and resistance as compared to the prior art. The second end 162 is configured to electrically connect to the PCBA 126. In the illustrated embodiment, the second end 162 defines an aperture 166 (e.g., a mounting aperture) which can receive a screw 170 (FIG. 7A) or other fastener to form a direct connection with the PCBA 126. In other embodiments, the aperture 166 can be omitted and the busbar 154 can be electrically attached to the PCBA 126 by another means, such as a solder connection (FIG. 7B), a clamped connection, a welded connection, or the like.

With reference to FIG. 6, each busbar 154 includes a plurality of portions or straight segments 172 including a first segment 172a, a second segment 172b, a third segment 172c, and a fourth segment 172d. Each of the straight segments 172 are oriented non-parallel to one another and are joined to one another at non-linear portions 176. Because the busbars 154 are rigid, the busbars 154 can be pre-formed (e.g., stamped, bent, etc.) with a non-linear shape comprising multiple non-parallel straight segments 172 in order to extend unobstructed through the housing 114 of the power tool 100.

With reference to FIG. 8, all or portions of the busbar 154 can be coupled to the housing 114 via molding. For example, in some embodiments, the busbar 154 can be insert molded with the housing 114. In such embodiments, the busbar 154 can be substantially embedded within the resin material forming the housing 114, or the busbar 154 can be partially embedded such that portions of the busbar 154 remain substantially exposed. Insert molding the busbar 154 to the housing 114 can simplify and speed the assembly process of the power tool 100. And, exposed portions of the busbar 154 can improve heat dissipation from the power tool 100 by remaining exposed to cooling airflow moving through the power tool 100 during operation (e.g., which airflow is generated by a fan within the power tool 100). Exposed portions of the busbar 154 can also be selectively coupled to one or more heat sinks (not shown) within the housing 114 to further improve cooling.

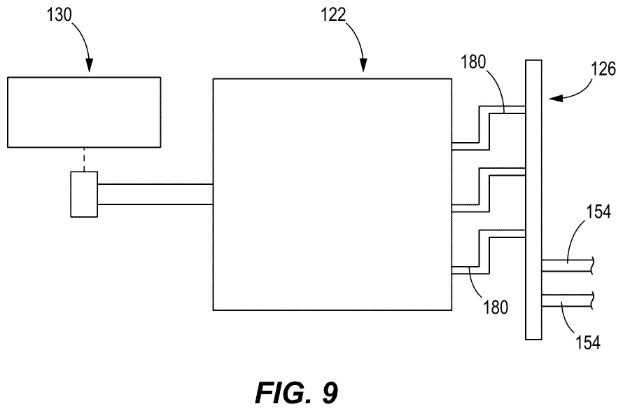

With reference to FIG. 9, in some embodiments, the power tool 10 includes busbars 180, such as phase busbars, which electrically connect the PCBA 126 to the electric motor 22. Like the busbars 154, the busbars 180 are formed from a conductive metal (e.g., copper, zinc, aluminum, alloys thereof, or other metals). Each busbar 180 can comprise a single monolithic part and can be relatively rigid, i.e., inflexible. The busbars 180 can also be coupled to the housing 114 via molding in a manner similar to that described herein for the busbars 154. One end of the busbars 180 can attach to the PCBA 126 via a threaded fastener, or by another means, such as a solder connection, a clamped connection, a welded connection, or the like. The other end of each busbar 180 can be secured to the electric motor 22, such as to a stator insulator (not shown), and can connect to the respective phases of the motor windings (not shown) to supply the current for each winding phase.

Although the disclosure has been described in detail with reference to certain preferred embodiments, variations and modifications exist within the scope and spirit of one or more independent aspects of the disclosure as described. Various features and/or advantages of the disclosure are set forth in the following claims.

What is claimed is:

1. A power tool configured to selectively and removably couple to a battery pack, the power tool comprising:
a housing;
an electric motor;
a printed circuit board assembly configured to supply electrical current to the electric motor;
an output unit operably coupled to the electric motor;
a tool terminal block supported by the housing and including a tool terminal configured to electrically couple to the battery pack; and
a busbar extending between and electrically connecting the tool terminal to the printed circuit board assembly;
wherein at least a portion of the busbar defines the tool terminal.

2. The power tool of claim 1, wherein the housing comprises a resin material, and wherein the busbar is at least partially embedded within the resin material.

3. The power tool of claim 2, wherein the busbar is insert molded with the housing.

4. The power tool of claim 1, wherein the busbar is rigid and includes a plurality of straight segments connected by a plurality of non-linear portions.

5. The power tool of claim 4, wherein the plurality of straight segments comprises a first segment, a second segment, a third segment, and a fourth segment oriented non-parallel to one another and joined at the non-linear portions.

6. The power tool of claim 1, wherein the busbar includes a first end and a second end, the tool terminal being located at the first end, and the second end defining an aperture configured to receive a screw that fastens the second end to the printed circuit board assembly.

7. The power tool of claim 1, wherein the busbar is a first busbar and the tool terminal is a first tool terminal, and wherein the power tool further comprises a second tool terminal and a second busbar extending between and electrically connecting the second tool terminal and the printed circuit board assembly.

8. The power tool of claim 1, wherein the busbar comprises a single monolithic conductive member formed of a conductive metal selected from copper, zinc, aluminum, or an alloy thereof.

9. The power tool of claim 8, wherein at least a portion of the busbar is exposed within the housing to an airflow generated by a fan of the power tool to dissipate heat.

10. The power tool of claim 9, wherein the portion of the busbar that is exposed is thermally coupled to a heat sink disposed within the housing.

11. The power tool of claim 1, wherein the busbar includes a first end and a second end, the tool terminal being located at the first end, and the second end being electrically attached to the printed circuit board assembly by a solder connection.

12. The power tool of claim 1, wherein the power tool further comprises a plurality of phase busbars electrically connecting the printed circuit board assembly to respective phase windings of the electric motor.

13. The power tool of claim 12, wherein an end of each phase busbar is secured to a stator insulator of the electric motor.

14. The power tool of claim 12, wherein each phase busbar comprises a single monolithic conductive member formed of a conductive metal and coupled to the housing by molding.

15. The power tool of claim 1, wherein the tool terminal is a male terminal configured to be received by a corresponding female terminal of the battery pack.

16. A busbar for a portable, battery-powered power tool, the busbar comprising:
a single monolithic conductive member having:
a first end defining a tool terminal configured to mate with a battery pack terminal,
a second end configured to electrically attach to a printed circuit board assembly, and
a plurality of straight segments joined by non-linear portions between the first end and the second end;
wherein the busbar is rigid and formed from a conductive metal.

17. The busbar of claim 16, wherein the second end defines a mounting aperture configured to receive a threaded fastener to couple the busbar to the printed circuit board assembly.

18. The busbar of claim 16, wherein the busbar is configured to be insert-molded into a housing of the portable, battery-powered power tool.

19. A method of assembling a portable, battery-powered power tool, the method comprising:
insert-molding a busbar in a housing of the portable, battery-powered power tool, the busbar having a first end and a second end; and
electrically attaching the second end of the busbar to a printed circuit board assembly of the portable, battery-powered power tool;
wherein the first end of the busbar defines a tool terminal configured to mate with a battery pack terminal of a battery pack.

20. The method of claim 19, further comprising inserting a screw through an aperture in the second end of the busbar and fastening the second end to the printed circuit board assembly via the screw, wherein the busbar is rigid and is formed of copper, zinc, aluminum, or an alloy thereof.
